(19) United States
(12) Patent Application Publication
(10) Pub. No.: US 2025/0005496 A1
(43) Pub. Date: Jan. 2, 2025

(54) METHOD AND DEVICE OF LONG-DISTANCE PUNCHING FOR POWER GENERATION ENTERPRISES

(71) Applicant: China Southern Power Grid Energy Storage Co., Ltd. Information and Communication Branch, Guangzhou (CN)

(72) Inventors: Jianxu ZHONG, Guangzhou (CN); Lingzhi XI, Guangzhou (CN); Feng CAO, Guangzhou (CN); Shaofeng YU, Guangzhou (CN); Jishuang HAN, Guangzhou (CN); Ritang LI, Guangzhou (CN); Chongyang LIAO, Guangzhou (CN); Xin YAN, Guangzhou (CN); Zehan CAI, Guangzhou (CN)

(21) Appl. No.: 18/799,443

(22) Filed: Aug. 9, 2024

Related U.S. Application Data
(63) Continuation of application No. PCT/CN2024/088704, filed on Apr. 19, 2024.

(30) Foreign Application Priority Data
Jun. 28, 2023 (CN) 202310768939.1

(51) Int. Cl. G06Q 10/0639

(52) U.S. Cl. CPC G06Q 10/06398

(57) ABSTRACT

Disclosed is a long-distance punching method and device for power generation enterprises, including the following steps: determining the employee geographical position of a target employee according to an employee identification code; calculating the distance value between employee geographical position and enterprise geographical position, and generating a long-distance punching strategy according to the distance value, demand punching time and demand punching method; calculating the time interval of employee punching time according to the timestamp, and generating the employee punching strategy; extracting a first core punching semantics in the long-distance punching strategy, extracting a second core punching semantics in the employee punching strategy, and calculating a matching value between the first core punching semantics and the second core punching semantics; and performing a feedback and updating of the employee punching strategy to obtain an updated employee punching strategy, and performing a long-distance punching according to the updated employee punching strategy.

### CROSS-REFERENCE TO RELATED APPLICATIONS

This disclosure is a continuation of PCT/CN2024/088704, filed on Apr. 19, 2024 and claims priority of Chinese Patent disclosure No. 202310768939.1, filed on Jun. 28, 2023, the entire contents of which are incorporated herein by reference.

### TECHNICAL FIELD

The disclosure relates to the technical field of semantic analysis, and in particular to a method and a device for long-distance punching for a power generation enterprise.

### BACKGROUND

With the development of society and the improvement of management system, there are more and more attendance systems, which are used to urge employees to work. However, in order to realize employees' long-distance punching and improve the accuracy of employees' long-distance punching, it is necessary to generate different punching strategies for long-distance punching.

At present, most of the punching methods in enterprises are to use fixed equipment, such as fingerprint identification attendance machine and face recognition attendance machine. In practical application, employees will do legwork, and only consider punching in a fixed place may cause some employees who are out of the office to be unable to punch, thus the accuracy of punching in a long distance for power generation enterprises is low.

### SUMMARY

The disclosure provides a method and a device for long-distance punching for a power generation enterprise, which mainly aims at solving the problem of low accuracy in long-distance punching for a power generation enterprise.

In order to achieve the above objective, the disclosure provides a long-distance punching method for a power generation enterprise, includes the following steps:
S1, obtaining an employee identification code of a target employee, and determining an employee geographical position of the target employee according to the employee identification code by using a preset dual positioning algorithm;
S2, obtaining an enterprise geographical position of a target power generation enterprise, calculating a distance value between the employee geographical position and the enterprise geographical position by using a preset distance algorithm, and generating a long-distance punching strategy according to the distance value, a preset demand punching time and preset demand punching methods, where calculating the distance value between the employee geographical position and the enterprise geographical position by using the preset distance algorithm, including:
S21, converting the employee geographical position into employee two-dimensional coordinates;
S22, converting the enterprise geographical position into enterprise two-dimensional coordinates;
S23, calculating a distance value between the employee two-dimensional coordinates and the enterprise two-dimensional coordinates according to a preset distance factor by using the distance algorithm as follows:

$$D = δ \times \sqrt{{( {x}_{1} - {x}_{2} )}^{2} - {( {y}_{1} - {y}_{2} )}^{2}} ;$$

where D is the distance value, δ is the distance factor, (X₁, y₁) is the employee two-dimensional coordinates, and (X₂, y₂) is the enterprise two-dimensional coordinates;
S3, obtaining an employee punching time and an employee punching method of the target employee, calculating a time interval of the employee punching time according to a preset timestamp, and generating an employee punching strategy according to the time interval and the employee punching method;
S4, extracting a first core punching semantics in the long-distance punching strategy, extracting a second core punching semantics in the employee punching strategy, and calculating a matching value between the first core punching semantics and the second core punching semantics by using a preset bidirectional matching algorithm; and
S5, performing a feedback and updating of the employee punching strategy according to the matching value to obtain an updated employee punching strategy, and performing a long-distance punching according to the updated employee punching strategy.

Optionally, determining the employee geographical position of the target employee according to the employee identification code by using the preset dual positioning algorithm, including:
determining a first position of the target employee through a first positioning in the dual positioning algorithm;
determining a mobile phone positioning position of the target employee according to the employee identification code through a second positioning in the dual positioning algorithm; and
obtaining the employee geographical position of the target employee by updating the first positioning according to the mobile phone positioning position.

Optionally, generating the long-distance punching strategy according to the distance value, the preset demand punching time and the preset demand punching methods, including:
when the distance value is greater than a preset distance threshold value, selecting a long-distance punching method among the demand punching methods;
determining a long-distance punching time according to the demand punching time and a preset punching interval; and
generating the long-distance punching strategy according to the long-distance punching method and the long-distance punching time.

Optionally, calculating the time interval of the employee punching time according to the preset timestamp, including:
obtaining a time point of the employee punching time;
calculating an interval time interval of the time point and the timestamp; and
aggregating the interval time interval into the time interval.

Optionally, generating an employee punching strategy according to the time interval and the employee punching method, including:
generating an employee punching table according to the employee identification code and a preset punching attribute;
determining an employee punching error marking according to the time interval; and
adding the time interval, the employee punching error marking and the employee punching method to the employee punching table to obtain the employee punching strategy.

Optionally, extracting the first core punching semantics in the long-distance punching strategy, including:
performing an attribute division of the long-distance punching strategy according to preset long-distance punching attributes to obtain long-distance punching division sequences;
performing vector conversions on the long-distance punching division sequences one by one to obtain long-distance punching vectors;
extracting a first attention weight of each punching word vector in the long-distance punching vectors by using a preset Bert model;
adding the first attention weights of same punching word vectors according to position codes of the each punching word vector to obtain a second attention weight; and
selecting a punching word vector with a highest second attention weight as the first core punching semantics.

Optionally, calculating the matching value between the first core punching semantics and the second core punching semantics by using the preset bidirectional matching algorithm, including:
performing a vector conversion on the second core punching semantics to obtain the second core punching vectors;
calculating a matching value between the long-distance punching vectors and the second core punching vectors by using the bidirectional matching algorithm, where the bidirectional matching algorithm is:

$$P = α \times ( {S}_{0} \times \frac{{\sum }_{i = 1}^{n} \frac{max ( {T}_{i} , {T}_{j} )}{{U}_{i}}}{n} ) + ( β \times \frac{{\sum }_{i = 1}^{n} ( {A}_{i} \times {U}_{i} )}{\sqrt{{\sum }_{i = 1}^{n} {A}_{i}^{2} \times {\sum }_{i = 1}^{n} {U}_{i}^{2}}} ) \times {S}_{0} ;$$

where P is the matching value, a is a first keyword weight in the long-distance punching vectors, β is a second keyword weight in the second core punching vectors, Tᵢ is a number of successful matching vectors of keyword vector i in forward matching, Tⱼ is a number of successful matching vectors of keyword vector j in negative matching, max is a maximum function, S₀ is an initial score of the long-distance punching vectors, n is a number of keyword vectors, Uᵢ is an i-th keyword vector in the long-distance punching vectors, and Aᵢ is an i-th keyword vector in the second core punching vectors.

Optionally, performing a feedback and updating of the employee punching strategy according to the matching value to obtain the updated employee punching strategy, including:
when the matching value is less than a preset matching threshold, performing a feedback marking on the employee punching strategy to obtain a marked punching strategy;
returning the marked punching strategy to the target employee to obtain an employee feedback punching strategy; and
performing the feedback and updating of the employee punching strategy according to the employee feedback punching strategy until feedback punching demand in the employee feedback punching strategy meets preset punching demand, and generating the updated employee punching strategy.

Optionally, performing the long-distance punching according to the updated employee punching strategy, including:
extracting an updated punching time and an updated punching method in the updated employee punching strategy; and
performing the long-distance punching of the target employee according to the updated punching time and the updated punching method.

In order to solve the above problems, the present invention also provides a power generation enterprise long-distance punching device, where the device includes:
an employee geographical position determining module, used for obtaining an employee identification code of a target employee and determining the employee geographical position of the target employee according to the employee identification code by using a preset dual positioning algorithm;
a long-distance punching strategy generating module, used for obtaining an enterprise geographical position of a target power generation enterprise, calculating a distance value between the employee geographical position and the enterprise geographical position by using a preset distance algorithm, and generating a long-distance punching strategy according to the distance value, a preset demand punching time and preset demand punching methods;
an employee punching strategy module, used for obtaining an employee punching time and an employee punching method of the target employee, calculating a time interval of the employee punching time according to a preset timestamp, and generating an employee punching strategy according to the time interval and the employee punching method;
a matching value calculating module, used for extracting a first core punching semantics in the long-distance punching strategy, extracting a second core punching semantics in the employee punching strategy, and calculating a matching value between the first core punching semantics and the second core punching semantics by using a preset bidirectional matching algorithm; and
a long-distance punching module, used for performing a feedback and updating of the employee punching strategy according to the matching value to obtain an updated employee punching strategy, and performing a long-distance punching according to the updated employee punching strategy.

According to the embodiment of the disclosure, the employee geographical position of the target employee is determined by the employee identification code, and then the distance value between the employee geographical position and the enterprise geographical position is calculated, and a long-distance punching strategy is generated according to the distance value, the demand punching time and the demand punching method, which is beneficial to judging the employee punching strategy and improving the accuracy of employees punching at a long distance; according to the punching time and mode of the target employee, the employee punching strategy is generated, and then the first core punching semantics in the long-distance punching strategy is matched with the second core punching semantics in the employee punching strategy, so that the authenticity of the long-distance punching of the employee may be judged; a feedback and updating of the employee punching strategy is performed according to the matching value to obtain an updated employee punching strategy, and a long-distance punching is realized according to the updated employee punching strategy, thus improving the accuracy of long-distance punching. Therefore, the method and the power generation enterprise long-distance punching device provided by the disclosure may solve the problem of low accuracy in long-distance punching in power generation enterprises.

### BRIEF DESCRIPTION OF THE DRAWINGS

FIG. 1 is a schematic flow chart of a long-distance punching method for a power generation enterprise according to an embodiment of the present disclosure.

FIG. 2 is a schematic flow chart for determining the employee geographical position according to an embodiment of the present disclosure.

FIG. 3 is a schematic flow chart for calculating a distance value according to an embodiment of the present disclosure.

FIG. 4 is a functional module diagram of a power generation enterprise long-distance punching device according to an embodiment of the present disclosure.

The realization, functional characteristics and advantages of the present disclosure will be further described with reference to the attached drawings in combination with embodiments.

### DETAILED DESCRIPTION OF THE EMBODIMENTS

It should be understood that the specific embodiments described here are only for explaining the disclosure, and are not used to limit the disclosure.

The embodiment of the application provides a long-distance punching method for a power generation enterprise. The execution subject of the long-distance punching method for a power generation enterprise includes, but is not limited to, at least one of electronic devices such as servers and terminals that may be configured to execute the method provided by the embodiment of the application. In other words, the long-distance punching method of a power generation enterprise may be implemented by software or hardware installed on terminal equipment or server equipment; the software may be a blockchain platform. The server includes, but is not limited to, a single server, a server cluster, a cloud server or a cloud server cluster. The server may be an independent server or a cloud server that provides basic cloud computing services such as cloud service, cloud database, cloud computing, cloud function, cloud storage, network service, cloud communication, middleware service, domain name service, security service, content delivery network (CDN), big data and artificial intelligence platform.

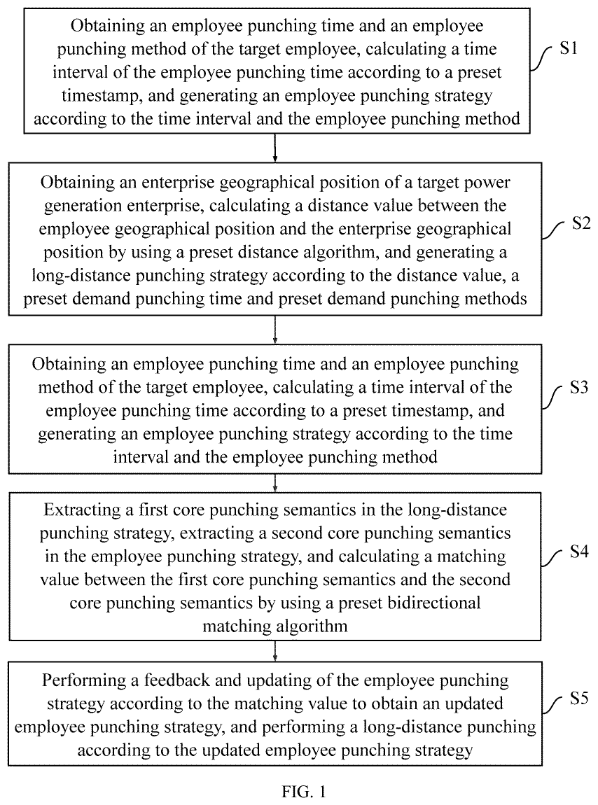

Referring to FIG. 1, it is a schematic flow chart of a long-distance punching method for a power generation enterprise according to an embodiment of the present disclosure. In this embodiment, the long-distance punching method for the power generation enterprise includes the following steps:

S1, obtaining an employee identification code of a target employee, and determining an employee geographical position of the target employee according to the employee identification code by using a preset dual positioning algorithm;

In the embodiment of the disclosure, the employee identification code is the unique identification of the employees in the power generation enterprise, and the unique identification of the employees may be determined by using the mobile phone number of each target employee, so as to prevent other employees from punching for others and ensure the uniqueness of employee punching.

In detail, computer statements (such as java statements, python statements, etc.) with data grabbing function may be used to grab the stored employee mobile phone numbers from a predetermined storage area, and the storage area includes but not limited to databases, blockchain nodes, and network caches.

Further, the employee geographical position is determined according to the employee identification code, so as to realize long-distance punching of employees according to the employee geographical position and improve the comprehensiveness of punching of power generation enterprises.

In the embodiment of the disclosure, the employee geographical position refers to the current employee's position, which generally consists of longitude and latitude, namely latitude and longitude. In order to locate the employee geographical position more accurately, a dual positioning algorithm is adopted to locate the employee's position.

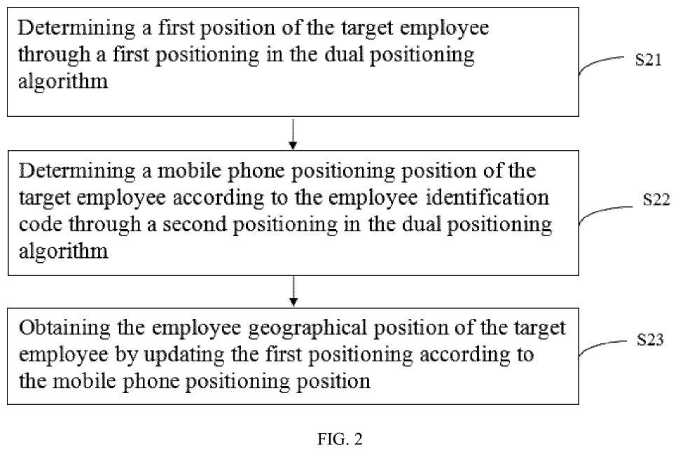

In the embodiment of the present disclosure, as shown in FIG. 2, determining the employee geographical position of the target employee according to the employee identification code by using the preset dual positioning algorithm, including:
S11, determining a first position of the target employee through a first positioning in the dual positioning algorithm;
S12, determining a mobile phone positioning position of the target employee according to the employee identification code through a second positioning in the dual positioning algorithm; and
S13, obtaining the employee geographical position of the target employee by updating the first positioning according to the mobile phone positioning position.

In detail, the dual positioning algorithm refers to the dual positioning mode of GPS+WiFi, where the first positioning is that the GPS positioning system obtains the first position of the target employee. Because the first position cannot uniquely determine the employee geographical position, it is necessary to uniquely determine the employee geographical position according to the employee identification code, and non-GPS is a satellite-based radio timing positioning and navigation system, and GPS positioning has the characteristics of high outdoor accuracy, short response time and wide information coverage.

Specifically, the second positioning refers to the positioning of each employee's mobile phone WiFi, positioning by mobile phone WiFi, where the positioning of each target employee's mobile phone is able to be determined by obtaining the MAC (physical) address of the client device. Therefore, the first location with deviation is updated according to the location of the mobile phone, and the employee geographical position uniquely determined by each target employee is obtained, so as to prevent employees from punching for others.

Further, according to the geographical position of the target employees and the geographical position between the power generation enterprise, different punching strategies may be generated according to the distance, and the punching accuracy of the power generation enterprises may be improved.

S2, obtaining an enterprise geographical position of a target power generation enterprise, calculating a distance value between the employee geographical position and the enterprise geographical position by using a preset distance algorithm, and generating a long-distance punching strategy according to the distance value, a preset demand punching time and preset demand punching methods;

In the embodiment of the disclosure, the enterprise geographical position is the enterprise position of the target power generation enterprise, where the coordinates that may be obtained by satellite positioning generally consist of two parameters, namely longitude and latitude.

Further, the distance value between the employee geographical position and the enterprise geographical position is calculated, and then the punching strategies of different power generation enterprises are generated according to the distance value.

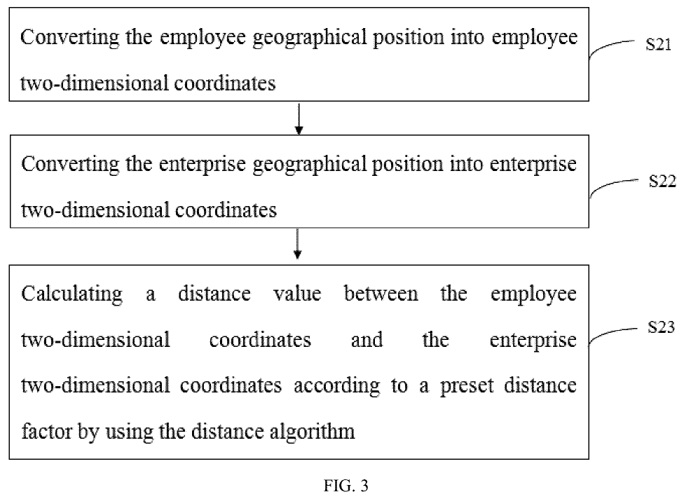

In the embodiment of the present disclosure, referring to FIG. 3, calculating the distance value between the employee geographical position and the enterprise geographical position by using the preset distance algorithm, including:
S21, converting the employee geographical position into employee two-dimensional coordinates;
S22, converting the enterprise geographical position into enterprise two-dimensional coordinates;
S23, calculating a distance value between the employee two-dimensional coordinates and the enterprise two-dimensional coordinates according to a preset distance factor by using the distance algorithm as follows:

$$D = δ \times \sqrt{{( {x}_{1} - {x}_{2} )}^{2} - {( {y}_{1} - {y}_{2} )}^{2}} ;$$

where D is the distance value, δ is the distance factor, (X₁, y₁) is the employee two-dimensional coordinates, and (X₂, y₂) is the enterprise two-dimensional coordinates.

In detail, the employee geographical position and the enterprise geographical position are determined by latitude and longitude, therefore, the employee geographical position and the enterprise geographical position should be converted into employee two-dimensional coordinates and enterprise two-dimensional coordinates, where the latitude and longitude in the geographical position may be converted into plane two-dimensional coordinates by a seven-parameter method, and the seven-parameter method means that two spatial rectangular coordinate systems are 01-X₁Y₁Z₁ and 02-X₂Y₂Z₂, respectively, and the origins are inconsistent. The corresponding coordinate axes are not parallel to each other, and besides three translation parameters, there are three Euler angles between the two coordinate axes, that is, three rotation parameters. Considering that the scales of the two coordinate systems are different, a scale change parameter m is needed, and there are seven parameters in total, so the transformation of spatial rectangular coordinate system with seven parameters, including but is not limited to Bursa formula, MoloDensky formula and normal form formula.

Specifically, the δ in the distance formula is the distance factor, meaning the difference value between the actual distance and the straight line distance between the employee geographical position and the power generation enterprise geographical position, so as to prevent the error between the employee geographical position and the power generation enterprise geographical position from being too large, and use the distance factor to improve the accuracy of the distance value calculation and realize the deviation of the distance value from the actual distance value.

Further, according to the different distance values, different distance punching strategies are generated, and then the accuracy of the punching strategy of the target employee is determined according to the punching strategy.

In the embodiment of the disclosure, the long-distance punching strategy refers to a punching strategy adopted when the employee position is too far away from the position of power generation enterprise.

In the embodiment of the present disclosure, generating the long-distance punching strategy according to the distance value, the preset demand punching time and the preset demand punching methods, including:
when the distance value is greater than a preset distance threshold value, selecting a long-distance punching method among the demand punching methods;
determining a long-distance punching time according to the demand punching time and a preset punching interval; and
generating the long-distance punching strategy according to the long-distance punching method and the long-distance punching time.

In detail, when the distance value is greater than the preset distance threshold, it is judged that the current employee is punching at a long distance, and an appropriate long-distance punching method needs to be selected from the demand punching methods. When the distance value is less than or equal to the distance threshold and the punching distance is within the preset punching range, it is determined that the current employee is punching at close distance, and punching at close distance is enough according to the preset punching range, where the demand punching methods include but are not limited to uploading photos, punching by fingerprints, punching by software applets, punching by induction cards, etc., and the long-distance punching method is punching by uploading photos or software applets.

Specifically, the demand punching time refers to the punching time on duty and the punching time off duty, and the punching interval refers to the punching allowed time. If the demand punching time is 8:00, 12:00 and 6:00, and the punching interval is {−10, +10}, the punching time is {7:50, 8:10}, {11:50, 12:10}, and {after 6:00}, and then a long-distance punching strategy is generated according to the long-distance punching method and the long-distance punching time, that is, the long-distance punching of employees is completed by uploading photos within the long-distance punching time.

Further, in order to ensure the accuracy of employees' long-distance punching, it is necessary to update the employee punching strategy according to the long-distance punching strategy to improve the accuracy of employee punching.

S3, obtaining an employee punching time and an employee punching method of the target employee, calculating a time interval of the employee punching time according to a preset timestamp, and generating an employee punching strategy according to the time interval and the employee punching method.

In the embodiment of the disclosure, the employee punching time includes the employee punching time in the morning, punching time at noon and punching time at night; the employee punching method includes uploading photos and punching by software applet.

In detail, computer statements (such as java statements, python statements, etc.) with data capture function may be used to capture the stored employee punching time and employee punching method from a predetermined storage area, including but not limited to databases, blockchain nodes, and network caches.

Furthermore, the employee punching strategy is generated according to the employee punching time and employee punching method, and then the employee punching strategy is matched with the long-distance punching strategy to ensure the accuracy of employee punching.

In the embodiment of the disclosure, the timestamp is the standard time point of punching according to different punching times, and is used for judging the employee punching time, so as to determine whether the employees punch in within the specified time for going to work, and realize the accurate judgment of the employee's late record.

In the embodiment of the present disclosure, calculating the time interval of the employee punching time according to the preset timestamp, including:
obtaining a time point of the employee punching time;
calculating an interval time interval of the time point and the timestamp; and
aggregating the interval time interval into the time interval.

In detail, the time point refers to the time when employee is punching, and the interval time interval refers to the time interval between the employee punching time and the standard time point, and then the interval time intervals of different punching time periods are aggregated to form the time interval of the employee punching time.

For example, the time points of employee punching time are 8:05, 12:04 and 6:10, and the corresponding timestamps of each time point are 8:00, 12:00 and 6:00, then the interval time interval between the time points of employee punching time at different times is calculated, and then the interval time interval is +5, +4 and +10, and then all the interval time intervals are aggregated as time intervals {+5, +4, +10}, with the unit of minutes.

Furthermore, the employee punching strategy is generated according to the punching time interval and punching method of employees, and then the employee punching strategy is compared with the long-distance punching strategy to determine the accuracy of the employee punching strategy.

In the embodiment of the present disclosure, generating an employee punching strategy according to the time interval and the employee punching method, including:
generating an employee punching table according to the employee identification code and a preset punching attribute;
determining an employee punching error marking according to the time interval; and
adding the time interval, the employee punching error marking and the employee punching method to the employee punching table to obtain the employee punching strategy.

In detail, the employee identification code is used to uniquely identify the target employee, and the punching attributes include punching time, punching method, punching error marking, time interval, etc., and then an employee punching table is generated according to the employee identification code and punching attributes, and the employee punching record is recorded in the employee punching table, so that the employee punching record may be queried later and the attendance of the employee may be realized conveniently.

Specifically, if the time interval is {+5, +4, +10} and the standard time difference is {7:50-8:10}, {11:50-12:10}, {6:00-}, the standard time intervals determined by the standard time difference are {(−10, +10), (−10, +10), (0)}. If the time interval of each punching time point is within the standard time interval, the employee punching error marking is 0. If at least one time interval of punching time is not within the standard time interval, the employee punching error marking is 1, where the punching time error marking of employees with normal punching time is 0, and the punching time error marking of employees with abnormal punching time is 1.

Further, the time interval, the employee punching error marking and the employee punching method are added to the corresponding punching attributes in the employee punching table, so that the employee punching strategy of each employee may be obtained according to the employee identification code of each employee. The employee punching strategy includes employee punching time, employee punching time interval, employee punching error and employee punching method.

Furthermore, the employee punching strategy is matched with the long-distance punching strategy, so as to determine whether the employee punching strategy meets the long-distance punching strategy and improve the accuracy of employee attendance.

S4, extracting a first core punching semantics in the long-distance punching strategy, extracting a second core punching semantics in the employee punching strategy, and calculating a matching value between the first core punching semantics and the second core punching semantics by using a preset bidirectional matching algorithm;

In the embodiment of the disclosure, the first core punching semantics refers to the punching method and punching time in the long-distance punching strategy, and the second core punching semantics refers to the punching method, punching error time and punching time in the employee punching strategy.

In the embodiment of the present disclosure, extracting the first core punching semantics in the long-distance punching strategy, including:
performing an attribute division of the long-distance punching strategy according to preset long-distance punching attributes to obtain long-distance punching division sequences;
performing vector conversions on the long-distance punching division sequences one by one to obtain long-distance punching vectors;
extracting a first attention weight of each punching word vector in the long-distance punching vectors by using a preset Bert model;
adding the first attention weights of same punching word vectors according to position codes of the each punching word vector to obtain a second attention weight; and
selecting a punching word vector with a highest second attention weight as the first core punching semantics.

In detail, the long-distance punching attributes include punching method and punching time. According to the long-distance punching attributes, the punching strategies of all employees in the long-distance punching strategy are divided according to the same punching attribute to obtain a long-distance punching division sequence. If the punching method of the target employee 1 is at the time point 1 of uploading photos and the punching method of the target employee 2 is at the time point 2 of uploading photos, the corresponding long-distance punching division sequence is {time point 1, time point 2}. The vector conversion is performed on the long-distance punching division sequences one by one to obtain a long-distance punching vector, where the long-distance punching division sequence may be converted into a long-distance punching vector by using a preset vector conversion model, including but not limited to word2vec model and Bert model.

Specifically, in the Bert model, the vector conversion is performed on each long-distance punching division sequence, and each long-distance punching vector has attention weight, and the attention weight of the long-distance punching vector is generated according to the last layer encoder in the Bert model. In the Bert model, there is a self-attention mechanism. The core logic of the self-attention mechanism is from paying attention to the whole to paying attention to the key points. When facing a scene, a specific part is often observed and paid attention to as needed. The Bert model uses the self-attention mechanism to pay attention to the expression of its own sequence. In the document coding representation generated by different layers of the BERT model, the vectorized representation output by the last layer encoder has higher semantic and grammatical information than that of other layers, so the word vector attention weight matrix generated by the last layer encoder is more in line with the semantic similarity compared with other layers. Since the self-attention mechanism in the BERT model uses the multi-head attention method, each head will generate an attention weight matrix, so the last layer encoder will generate multiple attention weight matrices, and each of the attention weight matrix represents the similarity between the word vectors captured by the corresponding head, and the line corresponding to the “[CLS]” tag is extracted from the attention weight matrix corresponding to each head, and this line represents the attention weight of the “[CLS]” tag captured by the head to the word vectors in all positions in the document.

For example, when the long-distance punching sequence includes punching time, punching method, punching personnel and punching address, the attention weights are respectively: “punching time”: 0.1, “punching method”: 0.2, “punching personnel”: 0.3, “punching address”: 0.3, “punching address”: 0.3, “punching method”: 0.1, “punching personnel”: 0.1, “punching time”: 0.5, “punching time”: 0.3, “punching method”: 0.1, the attention weights of the same long-distance punching vectors are added, that is, “punching time”: 0.6, “punching method”: 0.4, “punching personnel”: 0.4 and “punching address”: 0.6, then the core decision semantics in the interception decision basis are punching time and punching address.

Further, the step of extracting the second core punching semantics in the employee punching strategy is consistent with the step of extracting the first core punching semantics in the long-distance punching strategy, and the details are not repeated here.

In the embodiment of the disclosure, the matching value is used to measure the matching degree between the long-distance punching strategy and the employee punching strategy, so as to judge the punching accuracy of the employee punching strategy.

In the embodiment of the present disclosure, calculating the matching value between the first core punching semantics and the second core punching semantics by using the preset bidirectional matching algorithm, including:
performing a vector conversion on the second core punching semantics to obtain the second core punching vectors;
calculating a matching value between the long-distance punching vectors and the second core punching vectors by using the bidirectional matching algorithm, where the bidirectional matching algorithm is:

$$P = α \times ( {S}_{0} \times \frac{{\sum }_{i = 1}^{n} \frac{max ( {T}_{i} , {T}_{j} )}{{U}_{i}}}{n} ) + ( β \times \frac{{\sum }_{i = 1}^{n} ( {A}_{i} \times {U}_{i} )}{\sqrt{{\sum }_{i = 1}^{n} {A}_{i}^{2} \times {\sum }_{i = 1}^{n} {U}_{i}^{2}}} ) \times {S}_{0} ;$$

where P is the matching value, α is a first keyword weight in the long-distance punching vectors, β is a second keyword weight in the second core punching vectors, Tᵢ is a number of successful matching vectors of keyword vector i in forward matching, Tᵢ is a number of successful matching vectors of keyword vector j in negative matching, max is a maximum function, S₀ is an initial score of the long-distance punching vectors, n is a number of keyword vectors, Uᵢ is an i-th keyword vector in the long-distance punching vectors, and Aᵢ is an i-th keyword vector in the second core punching vectors.

In detail, vector conversion of the second core punching semantics is performed by using a preset vector conversion model to obtain a second core punching vector, where the vector conversion model includes but is not limited to word2vec model and Bert model.

Specifically, the bidirectional matching algorithm is to forward match and reverse match the long-distance punching vector and the second core punching vector, so as to improve the matching accuracy; where α in the bidirectional matching algorithm is the first keyword weight in the long-distance punching vector, β is the second keyword weight in the second core punching vector, α+B=1, and the keyword weights of a and B are customized according to the situation, S₀ is the initial score of the long-distance punching vector, and the initial score is also customized. Tᵢ is the number of successful matching vectors when one of the long-distance punching vectors is positively matched with the second core punching vector one by one, and Tⱼ is the number of successful matching vectors when one of the long-distance punching vectors is negatively matched with the second core punching vector one by one. By using positive matching and negative matching, the matching accuracy is improved.

Further, according to the matching value, the employee punching strategy is updated, so that more punching change time is reserved for employees within the specified time range, and the accuracy of the employee punching strategy is guaranteed.

S5, performing a feedback and updating of the employee punching strategy according to the matching value to obtain an updated employee punching strategy, and performing a long-distance punching according to the updated employee punching strategy.

In the embodiment of the disclosure, feedback and updating are performed on the employee punching strategy of the target employee according to the matching value within the punching time range specified by the employee, which reflects the humanization of the power generation enterprise, changes the punching time for the employee, and generates the optimal employee punching strategy.

In the embodiment of the disclosure, performing a feedback and updating of the employee punching strategy according to the matching value to obtain the updated employee punching strategy, including:
when the matching value is less than a preset matching threshold, performing a feedback marking on the employee punching strategy to obtain a marked punching strategy;
returning the marked punching strategy to the target employee to obtain an employee feedback punching strategy; and
performing the feedback and updating of the employee punching strategy according to the employee feedback punching strategy until feedback punching demand in the employee feedback punching strategy meets preset punching demand, and generating the updated employee punching strategy.

In detail, when the matching value is less than the preset matching threshold, it means that the employee punching strategy does not conform to the long-distance punching strategy, and the feedback and updating of employee punching strategy is performed to obtain a marked punching strategy, that is, a symbol is marked in the employee punching strategy, which means that the employee punching strategy needs to be returned to the target employee for updating, so that the target employee may update the punching time or punching method to obtain the employee's feedback punching strategy. Further, the feedback and updating of employee punching strategy is performed according to the employee feedback punching strategy, and the updated employee punching strategy is generated until the feedback punching demand in the employee feedback strategy meets the preset punching demand.

Specifically, the feedback punching demand refers to the updated punching time and updated punching method in the employee feedback punching strategy, and the punching demand refers to the standard punching time and standard punching method in the long-distance punching strategy, so as to generate an updated employee punching strategy only if the updated punching time is within the standard punching time range or the updated punching method meets the standard punching method.

Further, according to the updated employee punching strategy, the long-distance punching of employees is realized, so as to improve the accuracy of long-distance punching of power generation enterprises.

In the embodiment of the disclosure, performing the long-distance punching according to the updated employee punching strategy, including:
extracting an updated punching time and an updated punching method in the updated employee punching strategy; and
performing the long-distance punching of the target employee according to the updated punching time and the updated punching method.

In detail, the updated punching time and updated punching method in the updated employee punching strategy are added to the employee punching table, and then the stored employee punching table is captured from the predetermined storage area through computer statements (such as Java statements and python statements) with data capture function, and then the updated punching time and updated punching method in the employee punching table may be obtained.

Specifically, the long-distance punching of the target employee may be obtained according to the punching method selected by the employee and the employee punching time.

According to the embodiment of the disclosure, the employee geographical position of the target employee is determined by the employee identification code, and then the distance value between the employee geographical position and the enterprise geographical position is calculated, and a long-distance punching strategy is generated according to the distance value, the demand punching time and the demand punching method, which is beneficial to judging the employee punching strategy and improving the accuracy of employees punching at a long distance. According to the punching time and punching method of the target employee, the employee punching strategy is generated, and then the first core punching semantics in the long-distance punching strategy is matched with the second core punching semantics in the employee punching strategy, so that the authenticity of the long-distance punching of the employee may be judged. According to the matching value, the feedback and updating of the employee punching strategy is performed to obtain the updated employee punching strategy, and then the employee's long-distance punching is realized according to the updated employee punching strategy, thus improving the accuracy of power generation enterprises' long-distance punching. Therefore, the method and the device for long-distance punching in power generation enterprises provided by the disclosure may solve the problem of low accuracy in long-distance punching in power generation enterprises.

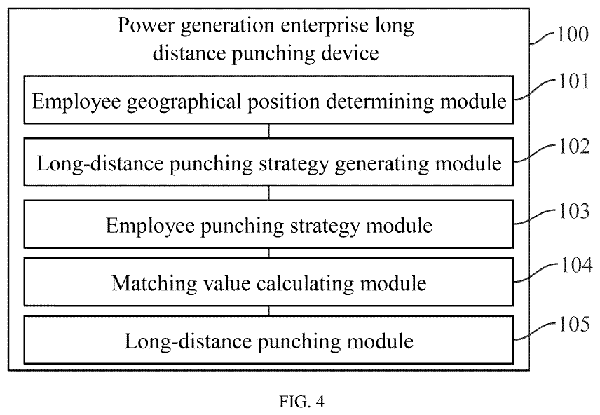

FIG. 4 is a functional module diagram of a device of long-distance punching for power generation enterprises provided by an embodiment of the present disclosure.

The power generation enterprise long-distance punching device 100 may be installed in electronic device. According to the realized functions, the power generation enterprise long-distance punching device 100 may include an employee geographical position determining module 101, a long-distance punching strategy generating module 102, an employee punching strategy module 103, a matching value calculating module 104 and a long-distance punching module 105. The module of the present disclosure may also be called a unit, which refers to a series of computer program segments that may be executed by the processor of electronic device and may complete fixed functions, and are stored in the memory of electronic device.

In this embodiment, the functions of each module/unit are as follows:
an employee geographical position determining module 101, used for obtaining an employee identification code of a target employee and determining the employee geographical position of the target employee according to the employee identification code by using a preset dual positioning algorithm;
a long-distance punching strategy generating module 102, used for obtaining an enterprise geographical position of a target power generation enterprise, calculating a distance value between the employee geographical position and the enterprise geographical position by using a preset distance algorithm, and generating a long-distance punching strategy according to the distance value, a preset demand punching time and preset demand punching methods;
an employee punching strategy module 103, used for obtaining an employee punching time and an employee punching method of the target employee, calculating a time interval of the employee punching time according to a preset timestamp, and generating an employee punching strategy according to the time interval and the employee punching method;
a matching value calculating module 104, used for extracting a first core punching semantics in the long-distance punching strategy, extracting a second core punching semantics in the employee punching strategy, and calculating a matching value between the first core punching semantics and the second core punching semantics by using a preset bidirectional matching algorithm; and
a long-distance punching module 105, used for performing a feedback and updating of the employee punching strategy according to the matching value to obtain an updated employee punching strategy, and performing a long-distance punching according to the updated employee punching strategy.

In detail, each module in the power generation enterprise long-distance punching device 100 in the embodiment of the present disclosure adopts the same technical means as the long-distance punching method for the power generation enterprise described in FIGS. 1-3, and may produce the same technical effect, which is not repeated here.

In several embodiments provided by the present disclosure, it should be understood that the disclosed devices and methods may be realized in other ways. For example, the device embodiment described above is only schematic. For example, the division of the module is only a logical function division, and there may be another division method in actual implementation.

The modules described as separate components may or may not be physically separated, and the components displayed as modules may or may not be physical units, that is, the modules may be located in one place or distributed to multiple network units. Some or all of the modules may be selected according to actual needs to achieve the objective of this embodiment.

In addition, each functional module in each embodiment of the present disclosure may be integrated in one processing unit, or each unit may exist physically alone, or two or more units may be integrated in one unit. The above integrated units may be realized in the form of hardware, or in the form of hardware plus software functional modules.

It is obvious to those skilled in the art that the present disclosure is not limited to the details of the above-mentioned exemplary embodiments, but may be realized in other specific forms without departing from the spirit or essential characteristics of the present disclosure.

Therefore, the embodiments should be considered in all aspects as illustrative and not restrictive, and the scope of the disclosure is defined by the appended claims rather than the above description, so it is intended to embrace all changes that fall within the meaning and range of equivalents of the claims. Any accompanying drawings in the claims shall not be regarded as limiting the related claims.

The embodiment of the application may acquire and process related data based on artificial intelligence technology. Artificial Intelligence (AI) is a theory, method, technology and disclosure system that uses digital computers or machines controlled by digital computers to simulate, extend and expand human intelligence, perceive the environment, acquire knowledge and use knowledge to obtain the best results.

In addition, it is obvious that the word “including” does not exclude other elements or steps, and the singular does not exclude the plural. A plurality of units or devices stated in the system embodiment may also be realized by one unit or device through software or hardware. The first and second words are used to indicate names, but do not indicate any particular order.

Finally, it should be noted that the above embodiments are only used to illustrate the technical scheme of the present disclosure, but not to limit it. Although the present disclosure has been described in detail with reference to the preferred embodiments, those skilled in the art should understand that the technical scheme of the present disclosure may be modified or replaced by equivalents without departing from the spirit and scope of the technical scheme of the present disclosure.

What is claimed is:

1. A long-distance punching method for a power generation enterprise, wherein the method comprises:
S1, obtaining an employee identification code of a target employee, and determining an employee geographical position of the target employee according to the employee identification code by using a preset dual positioning algorithm;
S2, obtaining an enterprise geographical position of a target power generation enterprise, calculating a distance value between the employee geographical position and the enterprise geographical position by using a preset distance algorithm, and generating a long-distance punching strategy according to the distance value, a preset demand punching time and preset demand punching methods, wherein calculating the distance value between the employee geographical position and the enterprise geographical position by using the preset distance algorithm, comprising:
S21, converting the employee geographical position into employee two-dimensional coordinates;
S22, converting the enterprise geographical position into enterprise two-dimensional coordinates;
S23, calculating a distance value between the employee two-dimensional coordinates and the enterprise two-dimensional coordinates according to a preset distance factor by using the distance algorithm as follows:
$$D = δ \times \sqrt{{( {x}_{1} - {x}_{2} )}^{2} - {( {y}_{1} - {y}_{2} )}^{2}} ;$$
wherein D is the distance value, δ is the distance factor, (X₁, y₁) is the employee two-dimensional coordinates, and (X₂, y₂) is the enterprise two-dimensional coordinates;
S3, obtaining an employee punching time and an employee punching method of the target employee, calculating a time interval of the employee punching time according to a preset timestamp, and generating an employee punching strategy according to the time interval and the employee punching method;
S4, extracting a first core punching semantics in the long-distance punching strategy, extracting a second core punching semantics in the employee punching strategy, and calculating a matching value between the first core punching semantics and the second core punching semantics by using a preset bidirectional matching algorithm; and
S5, performing a feedback and updating of the employee punching strategy according to the matching value to obtain an updated employee punching strategy, and performing a long-distance punching according to the updated employee punching strategy.

2. The long-distance punching method for the power generation enterprise according to claim 1,
wherein determining the employee geographical position of the target employee according to the employee identification code by using the preset dual positioning algorithm, comprising:
determining a first position of the target employee through a first positioning in the dual positioning algorithm;
determining a mobile phone positioning position of the target employee according to the employee identification code through a second positioning in the dual positioning algorithm; and
obtaining the employee geographical position of the target employee by updating the first positioning according to the mobile phone positioning position.

3. The long-distance punching method for the power generation enterprise according to claim 1,
wherein generating the long-distance punching strategy according to the distance value, the preset demand punching time and the preset demand punching methods, comprising:
when the distance value is greater than a preset distance threshold value, selecting a long-distance punching method among the demand punching methods;
determining a long-distance punching time according to the demand punching time and a preset punching interval; and
generating the long-distance punching strategy according to the long-distance punching method and the long-distance punching time.

4. The long-distance punching method for the power generation enterprise according to claim 1,
wherein calculating the time interval of the employee punching time according to the preset timestamp, comprising:
obtaining a time point of the employee punching time;
calculating an interval time interval of the time point and the timestamp; and
aggregating the interval time interval into the time interval.

5. The long-distance punching method for the power generation enterprise according to claim 1,
wherein generating an employee punching strategy according to the time interval and the employee punching method, comprising:
generating an employee punching table according to the employee identification code and a preset punching attribute;
determining an employee punching error marking according to the time interval; and
adding the time interval, the employee punching error marking and the employee punching method to the employee punching table to obtain the employee punching strategy.

6. The long-distance punching method for the power generation enterprise according to claim 1,
wherein extracting the first core punching semantics in the long-distance punching strategy, comprising:
performing an attribute division of the long-distance punching strategy according to preset long-distance punching attributes to obtain long-distance punching division sequences;
performing vector conversions on the long-distance punching division sequences one by one to obtain long-distance punching vectors;
extracting a first attention weight of each punching word vector in the long-distance punching vectors by using a preset Bert model;
adding the first attention weights of same punching word vectors according to position codes of the each punching word vector to obtain a second attention weight; and
selecting a punching word vector with a highest second attention weight as the first core punching semantics.

7. The long-distance punching method for the power generation enterprise according to claim 6,
wherein calculating the matching value between the first core punching semantics and the second core punching semantics by using the preset bidirectional matching algorithm, comprising:
performing a vector conversion on the second core punching semantics to obtain the second core punching vectors;
calculating a matching value between the long-distance punching vectors and the second core punching vectors by using the bidirectional matching algorithm, wherein the bidirectional matching algorithm is:
$$P = α \times ( {S}_{0} \times \frac{{\sum }_{i = 1}^{n} \frac{max ( {T}_{i} , {T}_{j} )}{{U}_{i}}}{n} ) + ( β \times \frac{{\sum }_{i = 1}^{n} ( {A}_{i} \times {U}_{i} )}{\sqrt{{\sum }_{i = 1}^{n} {A}_{i}^{2} \times {\sum }_{i = 1}^{n} {U}_{i}^{2}}} ) \times {S}_{0} ;$$
wherein P is the matching value, α is a first keyword weight in the long-distance punching vectors, β is a second keyword weight in the second core punching vectors, Tᵢ is a number of successful matching vectors of keyword vector i in forward matching, Tⱼ is a number of successful matching vectors of keyword vector j in negative matching, max is a maximum function, S₀ is an initial score of the long-distance punching vectors, n is a number of keyword vectors, Uᵢ is an i-th keyword vector in the long-distance punching vectors, and Aᵢ is an i-th keyword vector in the second core punching vectors.

8. The long-distance punching method for the power generation enterprise according to claim 1,
wherein performing a feedback and updating of the employee punching strategy according to the matching value to obtain the updated employee punching strategy, comprising:
when the matching value is less than a preset matching threshold, performing a feedback marking on the employee punching strategy to obtain a marked punching strategy;
returning the marked punching strategy to the target employee to obtain an employee feedback punching strategy; and
performing the feedback and updating of the employee punching strategy according to the employee feedback punching strategy until feedback punching demand in the employee feedback punching strategy meets preset punching demand, and generating the updated employee punching strategy.

9. The long-distance punching method for the power generation enterprise according to claim 1,
wherein performing the long-distance punching according to the updated employee punching strategy, comprising:
extracting an updated punching time and an updated punching method in the updated employee punching strategy; and
performing the long-distance punching of the target employee according to the updated punching time and the updated punching method.

10. A power generation enterprise long-distance punching device, wherein the device comprises:
an employee geographical position determining module, used for obtaining an employee identification code of a target employee and determining an employee geographical position of the target employee according to the employee identification code by using a preset dual positioning algorithm;
a long-distance punching strategy generating module, used for obtaining an enterprise geographical position of a target power generation enterprise, calculating a distance value between the employee geographical position and the enterprise geographical position by using a preset distance algorithm, and generating a long-distance punching strategy according to the distance value, a preset demand punching time and preset demand punching methods;
an employee punching strategy module, used for obtaining an employee punching time and an employee punching method of the target employee, calculating a time interval of the employee punching time according to a preset timestamp, and generating an employee punching strategy according to the time interval and the employee punching method;
a matching value calculating module, used for extracting a first core punching semantics in the long-distance punching strategy, extracting a second core punching semantics in the employee punching strategy, and calculating a matching value between the first core punching semantics and the second core punching semantics by using a preset bidirectional matching algorithm; and
a long-distance punching module, used for performing a feedback and updating of the employee punching strategy according to the matching value to obtain an updated employee punching strategy, and performing a long-distance punching according to the updated employee punching strategy.
